(19) United States
(12) Patent Application Publication
(10) Pub. No.: US 2025/0307998 A1
(43) Pub. Date: Oct. 2, 2025

(54) METHOD AND DEVICE FOR DENOISING DYNAMIC VIDEO

(71) Applicant: LITE-ON TECHNOLOGY CORPORATION, TAIPEI CITY (TW)

(72) Inventors: Kun Da LIN, TAIPEI CITY (TW); Yan-Wei LIU, TAIPEI CITY (TW); Tsung-Hung TSAI, TAIPEI CITY (TW)

(21) Appl. No.: 18/969,613

(22) Filed: Dec. 5, 2024

Related U.S. Application Data
(60) Provisional application No. 63/572,964, filed on Apr. 2, 2024.

(30) Foreign Application Priority Data
Jul. 30, 2024 (CN) 202411029498.4

(51) Int. Cl. G06T 5/70; G06T 5/50; G06T 5/60

(52) U.S. Cl. CPC G06T 5/70; G06T 5/50; G06T 5/60; G06T 2207/10016; G06T 2207/20084

(57) ABSTRACT

A method for denoising dynamic video is provided. The method is implemented by a device. The method includes obtaining a first image frame and a second image frame. The method includes inputting the first image frame and the second image frame to a first neural network model and a second neural network model, respectively, to generate a first optimized image frame and a second optimized image frame, wherein the first neural network model and the second neural network model are trained using a consistency loss.

### CROSS REFERENCE TO RELATED APPLICATIONS

This application claims the benefit of U.S. Provisional Application No. 63/572,964, entitled “Using Consistency Loss to Improve Stability of AI Video Denoising”, filed on Apr. 2, 2024, and China Patent Application No. 202411029498.4, filed on Jul. 30, 2024, which are expressly incorporated by reference herein in their entirety.

### BACKGROUND OF THE APPLICATION

### Field of the Application

The present disclosure generally relates to the field of image processing technologies. More specifically, aspects of the present disclosure relate to a method and device for denoising dynamic video using deep neural networks such as a Convolutional Neural Network (CNN).

### Description of the Related Art

In the field of dynamic video processing, maintaining the stability of the video is very important. Currently, more and more imaging products are equipped with artificial intelligence (AI) computing capabilities and perform video denoising through the use of AI algorithms.

However, the training process of a traditional AI image denoising model mainly involves optimizing the image frame restoration ability based on a single image frame input. For a single image frame, although the traditional AI image denoising model has good denoising capabilities, when the AI image denoising model denoises continuous-time dynamic videos, the dynamic videos often suffer from ghosting or shaking. The condition of instability affects the clarity and stability of dynamic videos.

Therefore, there is a need for a method and device for denoising dynamic video that can eliminate video noise and restore video details, so as to optimize dynamic videos and improve overall stability.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and device for denoising dynamic video is provided in the present disclosure.

In an exemplary embodiment, a method for denoising dynamic video is provided. The method is implemented by a device. The method includes obtaining a first image frame and a second image frame. The method includes inputting the first image frame and the second image frame to a first neural network model and a second neural network model, respectively, to generate a first optimized image frame and a second optimized image frame, wherein the first neural network model and the second neural network model are trained using a consistency loss.

In some embodiments, the consistency loss is calculated in a first convolutional layer in the first neural network model and a second convolutional layer in the second neural network model.

In some embodiments, the consistency loss L_{c} is expressed as:

$${L}_{c} = {\sum }_{l} \frac{λ}{{N}^{i}} {‖ {Φ}^{l} ( {\hat{Y}}^{l} ) - {Φ}^{l} ( {\hat{Y}}^{2} ) ‖}_{1}$$

wherein Ŷ¹ represents the first image frame, Ŷ² represents the second image frame, Φ^{l} represents visual geometry group (VGG) features at a l-th layer, and N^{l} represents the number of VGG features in the l-th layer, and λ is a normalization parameter.

In some embodiments, the method further comprises using a recovery loss to promote the first optimized image frame and the second optimized image frame to be close to a real image frame.

In some embodiments, the recovery loss Lᵣ is expressed as:

$${L}_{r} = {\sum }_{l} \frac{λ}{{N}^{l}} {\sum }_{k = 1 , 2} {‖ {Φ}^{l} ( {Y}^{*} ) - {Φ}^{l} ( {\hat{Y}}^{k} ) ‖}_{1}$$

wherein Y* represents the real image frame, Ŷ¹ represents the first image frame, Ŷ² represents the second image frame, Φ^{l} represents visual geometry group (VGG) features at a l-th layer, and N^{l} represents the number of VGG features in the l-th layer, and λ is a normalization parameter.

In some embodiments, the first image frame and the second image frame are two consecutive image frames randomly sampled from a pre-processed dynamic video.

In some embodiments, the pre-processed dynamic video is a dynamic video obtained through pre-processing.

In some embodiments, the pre-processing comprises Bayer to raw RGB conversion, black level subtraction, binning and global digital gain.

In some embodiments, the first image frame and the second image frame are input to the first neural network model and the second neural network model in a Siamese mode.

In some embodiments, the first neural network model and the second neural network model are deep Siamese network models.

In an exemplary embodiment, a device for denoising dynamic video is provided. The device comprises one or more processors and one or more computer storage media for storing one or more computer-readable instructions. The processor is configured to drive the computer storage media to execute the following tasks. The following tasks comprise obtaining a first image frame and a second image frame. The following tasks comprise inputting the first image frame and the second image frame to a first neural network model and a second neural network model, respectively, to generate a first optimized image frame and a second optimized image frame, wherein the first neural network model and the second neural network model are trained using a consistency loss.

### BRIEF DESCRIPTION OF DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram illustrating a device 100 for denoising dynamic video, according to an embodiment of the present disclosure.

FIG. 2 is a schematic diagram illustrating a method for denoising dynamic videos according to an embodiment of the present disclosure.

FIG. 3 is a flow chart illustrating a method 300 for denoising dynamic video according to an embodiment of the present disclosure.

FIG. 4 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

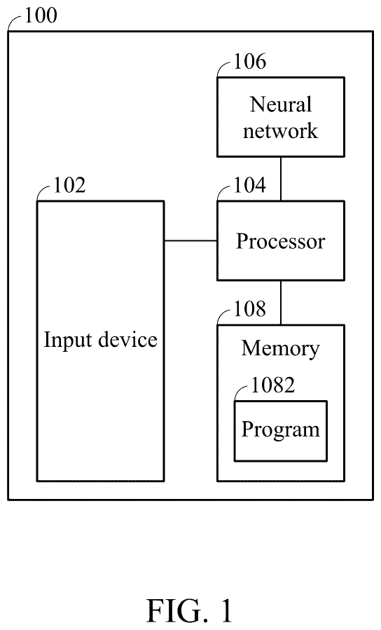

FIG. 1 is a schematic diagram illustrating a device 100 for denoising dynamic video, according to an embodiment of the present disclosure.

The device 100 may include an input device 102, wherein the input device 102 is configured to receive input data from various sources. For example, the device 100 may receive videos/image frames from the network or receive videos/image frames input by a user.

The device 100 also includes a processor 104, a neural network 106 and a memory 108 that may store a program 1082. In addition, the videos/image frames may be stored in the memory 108 or in the neural network 106. In one embodiment, the neural network 106 may be implemented by the processor 104.

Types of the devices 100 range from small handheld devices (e.g., mobile phones/portable computers) to large host systems (e.g., mainframe computers). Examples of portable computers include personal digital assistants (PDAs), notebook computers, and other devices.

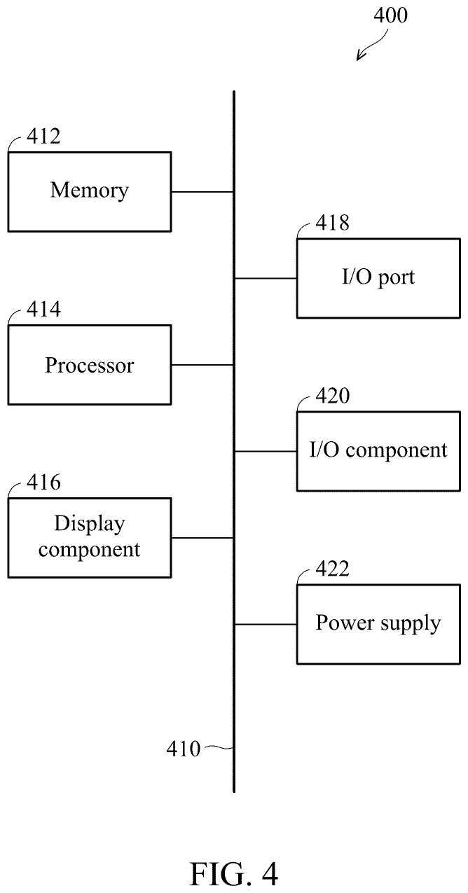

It should be understood that the device 110 shown in FIG. 1 may be implemented via any type of computing device, such as the electronic device 400 described with reference to FIG. 4, for example.

The following will describe in detail how the device for denoising dynamic video trains a neural network model to denoise images and generate optimized videos.

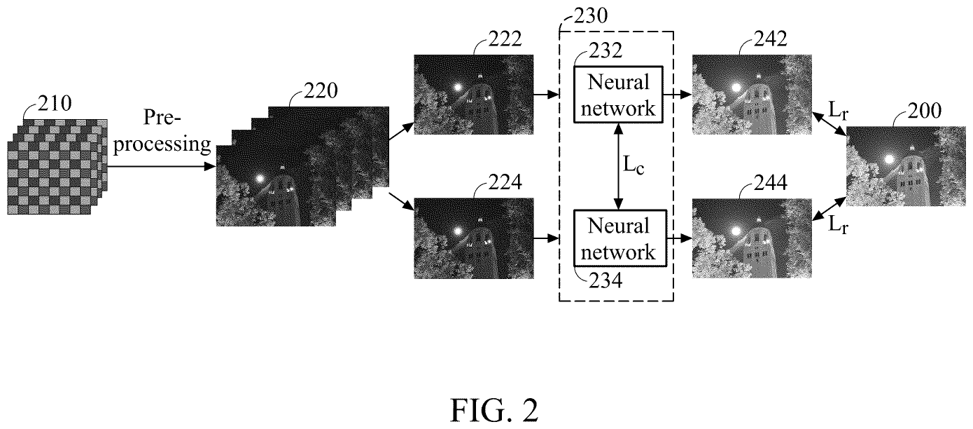

FIG. 2 is a schematic diagram illustrating a method for denoising dynamic videos according to an embodiment of the present disclosure. This method may be implemented by the processor 104 of the device 100 for denoising dynamic video in FIG. 1.

As shown in FIG. 2, the processor receives a video 210, wherein the video 210 is a video of dynamic scenes. In another embodiment, the video 210 is a Bayer raw video.

Next, the processor performs pre-processing on the video 210 to obtain a pre-processed video, where the pre-processing includes Bayer to raw RGB conversion, black level subtraction, binning and global digital gain. In FIG. 2, the pre-processed video may be composed of a plurality of consecutive image frames 220.

Next, the processor may randomly sample two consecutive image frames 222 and 224 from the pre-processed video and input the image frame 222 and the image frame 224 to the neural network model 232 and the neural network model 234, respectively. In one embodiment, the image frame 222 and the image frame 224 are input to the neural network model 232 and the neural network model 234 in a Siamese mode. In another embodiment, the neural network model 232 and the neural network model 234 are deep Siamese network models 230. In yet another embodiment, the neural network model 232 and the neural network model 234 are based on a convolutional neural network (CNN) model.

The neural network model 232 and the neural network model 234 are trained using the consistency loss L_{c} to generate an optimized image frame 242 and an optimized image frame 244, respectively. The consistency loss L_{c} is expressed by the following formula:

$${L}_{c} = {\sum }_{l} \frac{λ}{{N}^{i}} {‖ {Φ}^{l} ( {\hat{Y}}^{l} ) - {Φ}^{l} ( {\hat{Y}}^{2} ) ‖}_{1}$$

wherein Ŷ¹ represents the first image frame, Ŷ² represents the second image frame, Φ^{l} represents visual geometry group (VGG) features at a l-th layer, and N^{l} represents the number of VGG features in the l-th layer, and λ is a normalization parameter. In one embodiment, λ is empirically set to 0.05.

In one embodiment, the consistency loss L_{c} is calculated in a first convolutional layer in the neural network model 232 and a second convolutional layer in the neural network model 234. In another embodiment, the processor may randomly select one of the plurality of convolutional layers in the neural network model 232 as the first convolutional layer, and randomly select one of the plurality of convolutional layers in the neural network model 234 as the second convolutional layer.

Then, the processor may use a recovery loss Lᵣ to promote the optimized image frame 242 and the optimized image frame 244 to be close to a real image frame 200. The recovery loss Lᵣ is expressed by the following formula:

$${L}_{r} = {\sum }_{l} \frac{λ}{{N}^{l}} {\sum }_{k = 1 , 2} {‖ {Φ}^{l} ( {Y}^{*} ) - {Φ}^{l} ( {\hat{Y}}^{k} ) ‖}_{1}$$

wherein Y* represents the real image frame, Ŷ¹ represents the first image frame, Ŷ² represents the second image frame, Φ^{l} represents visual geometry group (VGG) features at a l-th layer, and N^{l} represents the number of VGG features in the l-th layer, and λ is a normalization parameter. In one embodiment, λ is empirically set to 0.05.

As shown in FIG. 2, the neural network model 232 and the neural network model 234 use the consistency loss L_{c} during the training process to compare the continuous image frames 222 and 224 and reduce the difference between the feature maps corresponding to different image frames 222 and 224.

It should be noted that although the neural network model 232 and the neural network model 234 in FIG. 2 only operate on a single image frame during the training process, the disclosure should not be limited thereto. For example, the neural network model 232 and the neural network model 234 may also operate on the dynamic video during the training process.

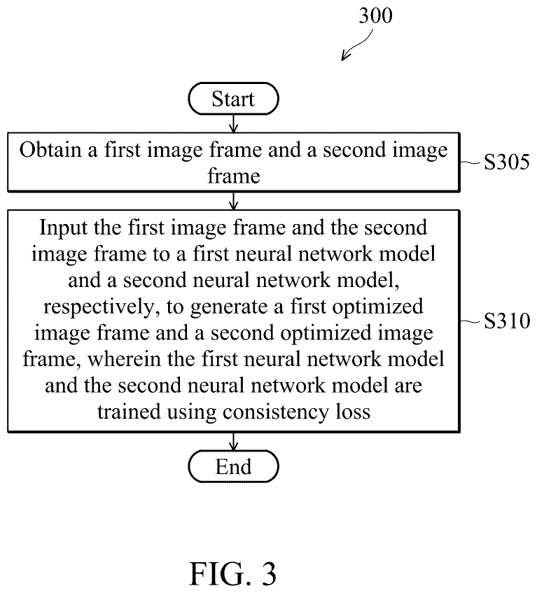

FIG. 3 is a flow chart illustrating a method 300 for denoising dynamic video according to an embodiment of the present disclosure. The method may be implemented by the processor 104 of the device 100 for denoising dynamic video in FIG. 1.

In step S305, the processor obtains a first image frame and a second image frame. In another embodiment, the first image frame and the second image frame are two consecutive image frames randomly sampled from a pre-processed dynamic video, wherein the pre-processed dynamic video is a dynamic video obtained through pre-processing and the dynamic video is a video of dynamic scenes.

In step S310, the processor inputs the first image frame and the second image frame to a first neural network model and a second neural network model, respectively, to generate a first optimized image frame and a second optimized image frame, wherein the first neural network model and the second neural network model are trained using consistency loss. In one embodiment, the consistency loss is calculated in a first convolutional layer in the first neural network model and a second convolutional layer in the second neural network model.

As mentioned above, the method and device for denoising dynamic video proposed in the present disclosure use the uses consistency loss to train the neural network models to denoise dynamic videos so that the dynamic videos have high image stability.

Having described embodiments of the present disclosure, an exemplary operating environment in which embodiments of the present disclosure may be implemented is described below. Referring to FIG. 4, an exemplary operating environment for implementing embodiments of the present disclosure is shown and generally known as an electronic device 400. The electronic device 400 is merely an example of a suitable computing environment and is not intended to limit the scope of use or functionality of the disclosure. Neither should the electronic device 400 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 4, the electronic device 400 may include a bus 410 that is directly or indirectly coupled to the following devices: one or more memories 412, one or more processors 414, one or more display components 416, one or more input/output (I/O) ports 418, one or more input/output components 420, and an illustrative power supply 422. The bus 410 may represent one or more kinds of busses (such as an address bus, data bus, or any combination thereof). Although the various blocks of FIG. 4 are shown with lines for the sake of clarity, and in reality, the boundaries of the various components are not specific. For example, the display component such as a display device may be considered an I/O component and the processor may include a memory.

The electronic device 400 typically includes a variety of computer-readable media. The computer-readable media can be any available media that can be accessed by electronic device 400 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 400. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 412 may include computer-storage media in the form of volatile and/or nonvolatile memory. The memory may be removable, non-removable, or a combination thereof. Exemplary hardware devices include solid-state memory, hard drives, optical-disc drives, etc. The electronic device 400 includes one or more processors that read data from various entities such as the memory 412 or the I/O components 420. The display component(s) 416 present data indications to a user or to another device. Exemplary presentation components include a display screen, etc.

The I/O ports 418 allow the electronic device 400 to be logically coupled to other devices including the I/O components 420, some of which may be embedded. Illustrative components include a microphone, joystick, wireless device, etc. The I/O components 420 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 400, or any combination thereof. The electronic device 400 may be equipped with depth cameras, such as stereoscopic camera systems, infrared camera systems, RGB camera systems, or any combination thereof, to realize gesture detection and recognition. Furthermore, the electronic device 400 may be equipped with accelerometers or gyroscopes that enable detection of motion. The output of the accelerometers or gyroscopes may be provided to the display of the electronic device 400 to carry out immersive augmented reality or virtual reality.

Furthermore, the processor 414 in the electronic device 400 can execute the program code in the memory 412 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for denoising dynamic video, wherein the method is implemented by a device and comprises:
obtaining a first image frame and a second image frame; and
inputting the first image frame and the second image frame to a first neural network model and a second neural network model, respectively, to generate a first optimized image frame and a second optimized image frame, wherein the first neural network model and the second neural network model are trained using a consistency loss.

2. The method for denoising dynamic video as claimed in claim 1, wherein the consistency loss is calculated in a first convolutional layer in the first neural network model and a second convolutional layer in the second neural network model.

3. The method for denoising dynamic video as claimed in claim 1, wherein the consistency loss L_{c} is expressed as:
$${L}_{c} = {\sum }_{l} \frac{λ}{{N}^{i}} {‖ {Φ}^{l} ( {\hat{Y}}^{l} ) - {Φ}^{l} ( {\hat{Y}}^{2} ) ‖}_{1}$$
wherein Ŷ¹ represents the first image frame, Ŷ² represents the second image frame, Φ^{l} represents visual geometry group (VGG) features at a l-th layer, and N^{l} represents the number of VGG features in the l-th layer, and λ is a normalization parameter.

4. The method for denoising dynamic video as claimed in claim 1, further comprising:
using a recovery loss to promote the first optimized image frame and the second optimized image frame to be close to a real image frame.

5. The method for denoising dynamic video as claimed in claim 4, wherein the recovery loss Lᵣ is expressed as:
$${L}_{r} = {\sum }_{l} \frac{λ}{{N}^{l}} {\sum }_{k = 1 , 2} {‖ {Φ}^{l} ( {Y}^{*} ) - {Φ}^{l} ( {\hat{Y}}^{k} ) ‖}_{1}$$
wherein Y* represents the real image frame, Ŷ¹ represents the first image frame, Ŷ² represents the second image frame, Φ^{l} represents visual geometry group (VGG) features at a 1-th layer, and N^{l} represents the number of VGG features in the l-th layer, and λ is a normalization parameter.

6. The method for denoising dynamic video as claimed in claim 1, wherein the first image frame and the second image frame are two consecutive image frames randomly sampled from a pre-processed dynamic video.

7. The method for denoising dynamic video as claimed in claim 6, wherein the pre-processed dynamic video is a dynamic video obtained through pre-processing.

8. The method for denoising dynamic video as claimed in claim 7, wherein the pre-processing comprises Bayer to raw RGB conversion, black level subtraction, binning and global digital gain.

9. The method for denoising dynamic video as claimed in claim 1, wherein the first image frame and the second image frame are input to the first neural network model and the second neural network model in a Siamese mode.

10. The method for denoising dynamic video as claimed in claim 1, wherein the first neural network model and the second neural network model are deep Siamese network models.

11. The method for denoising dynamic video as claimed in claim 1, wherein the first neural network model and the second neural network model are based on a convolutional neural network (CNN) model.

12. A device for denoising dynamic video, comprising:
one or more processors; and
one or more computer storage media for storing one or more computer-readable instructions, wherein the processor is configured to drive the computer storage media to execute the following tasks:
obtaining a first image frame and a second image frame; and
inputting the first image frame and the second image frame to a first neural network model and a second neural network model, respectively, to generate a first optimized image frame and a second optimized image frame, wherein the first neural network model and the second neural network model are trained using a consistency loss.

13. The device for denoising dynamic video as claimed in claim 12, wherein the consistency loss is calculated in a first convolutional layer in the first neural network model and a second convolutional layer in the second neural network model.

14. The device for denoising dynamic video as claimed in claim 12, wherein the consistency loss L_{c} is expressed as:
$${L}_{c} = {\sum }_{l} \frac{λ}{{N}^{i}} {‖ {Φ}^{l} ( {\hat{Y}}^{l} ) - {Φ}^{l} ( {\hat{Y}}^{2} ) ‖}_{1}$$
wherein Ŷ¹ represents the first image frame, Ŷ² represents the second image frame, Φ^{l} represents visual geometry group (VGG) features at a l-th layer, and N^{l} represents the number of VGG features in the l-th layer, and A is a normalization parameter.

15. The device for denoising dynamic video as claimed in claim 12, wherein the processor further executes the following tasks:
using a recovery loss to promote the first optimized image frame and the second optimized image frame to be close to a real image frame.

16. The device for denoising dynamic video as claimed in claim 15, wherein the recovery loss Lᵣ is expressed as:
$${L}_{r} = {\sum }_{l} \frac{λ}{{N}^{l}} {\sum }_{k = 1 , 2} {‖ {Φ}^{l} ( {Y}^{*} ) - {Φ}^{l} ( {\hat{Y}}^{k} ) ‖}_{1}$$
wherein Y* represents the real image frame, Ŷ¹ represents the first image frame, Ŷ² represents the second image frame, Φ^{l} represents visual geometry group (VGG) features at a l-th layer, and N^{l} represents the number of VGG features in the l-th layer, and λ is a normalization parameter.

17. The device for denoising dynamic video as claimed in claim 12, wherein the first image frame and the second image frame are two consecutive image frames randomly sampled from a pre-processed dynamic video.

18. The device for denoising dynamic video as claimed in claim 17, wherein the pre-processed dynamic video is a dynamic video obtained through pre-processing.

19. The device for denoising dynamic video as claimed in claim 18, wherein the pre-processing comprises Bayer to raw RGB conversion, black level subtraction, binning and global digital gain.

20. The device for denoising dynamic video as claimed in claim 12, wherein the first image frame and the second image frame are input to the first neural network model and the second neural network model in a Siamese mode.

21. The device for denoising dynamic video as claimed in claim 12, wherein the first neural network model and the second neural network model are deep Siamese network models.

22. The device for denoising dynamic video as claimed in claim 12, wherein the first neural network model and the second neural network model are based on a convolutional neural network (CNN) model.
